(19) United States
(12) Patent Application Publication
(10) Pub. No.: US 2015/0377340 A1
(43) Pub. Date: Dec. 31, 2015

(54) CONTROL DEVICE

(71) Applicant: Ayato NOMORI, (US)

(72) Inventor: Ayato NOMORI, Okazaki-shi (JP)

(73) Assignee: TOYOTA JIDOSHA KABUSHIKI KAISHA, Toyota-shi, Aichi-ken (JP)

(21) Appl. No.: 14/765,033

(22) PCT Filed: Feb. 7, 2014
(86) PCT No.: PCT/IB2014/000127

§ 371 Date: Jul. 31, 2015

(30) Foreign Application Priority Data
Feb. 12, 2013 (JP) 2013-024818

(51) Int. Cl. F16H 57/04; F16H 63/50; F16H 59/36; F02D 29/02; F16H 59/72

(52) U.S. Cl. CPC F16H 57/0408; F02D 29/02; F16H 57/0447; F16H 59/72; F16H 59/36; F16H 63/50; F16H 2059/366

(57) ABSTRACT

A control device including: an oil pump configured to be driven by an engine; an oil amount adjusting apparatus configured to adjust an oil level in an oil storage container of a vehicle automatic transmission; the oil amount adjusting apparatus including: a discharge tube provided upright on a bottom wall of the oil storage container in a liquid-tight manner; the discharge tube being configured to discharge oil that exceeds a discharge height that is defined by a height of the discharge tube; a controller configured to control the engine so as to obtain an oil surface height that is appropriate for adjustment of the oil level by the oil amount adjusting apparatus, the controller being configured to control a revolution number of the engine so as to maintain the oil surface height of the oil in a predetermined appropriate range regardless of a temperature of the oil.

### BACKGROUND OF THE INVENTION

1. Field of the Invention

The present invention relates to an oil amount adjusting mechanism for an automatic transmission that adjusts an oil level in an oil storage container and particularly to a technique that maintains an oil surface height in an appropriate range for a relatively long time and extends an operation time in which the oil amount adjusting mechanism adjusts the oil level.

2. Description of Related Art

A hydraulic device for a vehicle that requires oil when an automatic transmission operates is housed in a case of the automatic transmission in a liquid-tight manner. An example of a structure that adjusts an oil level of the oil stored in an oil storage container that is provided in a lower section of the case may be an overflow type oil amount adjusting mechanism disclosed by Japanese Patent Application Publication No. 2010-007792 (JP 2010-007792 A) and so forth. The oil amount adjusting mechanism sets the oil level by vertically disposing a discharge tube in a drain hole in a bottom wall of the oil storage container and discharging the oil that exceeds a discharge height that is determined by the length of the discharge tube from the drain hole through the discharge tube.

The oil amount adjusting mechanism for the automatic transmission sets the oil level such that an appropriate oil amount is obtained in a condition that the discharge height of the discharge tube is predetermined and the oil is at a prescribed temperature. For example, during adjustment of the oil level, the oil level varies when the oil temperature differs from the prescribed temperature even if the oil amount is the same. Therefore, as disclosed in JP 2010-007792 A, Japanese Patent Application Publication 2006-177450 (JP 2006-177450 A), and Japanese Patent Application Publication No. 11-325235 (JP 11-325235 A), the oil amount adjusting mechanism adjusts the oil level after the oil is warmed to the prescribed temperature by driving an engine.

### SUMMARY OF THE INVENTION

However, such a method as above has a problem that the oil temperature relatively quickly exceeds the prescribed temperature, a time allowed for an oil level adjusting operation by the oil amount adjusting mechanism becomes relatively short, and work efficiency is thus lowered.

The present invention provides a control device that extends an oil level adjusting operation time by an oil amount adjusting mechanism for a vehicle automatic transmission and improves work efficiency.

The inventors conducted various analyses and examinations on the basis of the above circumstance and found a fact described below. First, the oil temperature is increased while a constant engine revolution number is maintained in a vehicle that includes an oil pump driven by the engine. In this case, a returning oil amount from each section of the automatic transmission increases due to an increase in the oil volume and a decrease in the oil viscosity, resulting in a rise in the oil surface height. On the other hand, the engine revolution number is increased while a constant oil temperature is maintained. In this case, the oil surface height is determined according to the balance between a pumped-up oil amount by the oil pump and the returning oil amount from each section of the automatic transmission. Because the pumped-up oil amount is more sensitive to the engine revolution number in general, the oil surface height lowers. According to these phenomena, the engine revolution number is controlled to increase according to the oil temperature, the oil surface height can thereby be maintained regardless of the oil temperature, and the operation time can thus be extended.

An aspect of the present invention provides a control device including an oil pump configured to be driven by an engine; an oil amount adjusting apparatus configured to adjust an oil level in an oil storage container of a vehicle automatic transmission, the oil amount adjusting apparatus including: a discharge tube provided upright on a bottom wall of the oil storage container in a liquid-tight manner, the discharge tube connecting to a drain hole that is formed in the bottom wall of the oil storage container, the discharge tube configured to discharge oil in the oil storage container through the drain hole and the discharge tube, the discharge tube being configured to discharge oil that exceeds a discharge height that is defined by a height of the discharge tube; a controller configured to control the engine so as to obtain an oil surface height that is appropriate for adjustment of the oil level by the oil amount adjusting apparatus, the control apparatus configured to control a revolution number of the engine so as to maintain the oil surface height of the oil in a predetermined appropriate range regardless of a temperature of the oil.

According to the control device that is configured as described above, the revolution number of the engine is controlled so as to maintain the oil surface height of the oil in a predetermined appropriate range regardless of the temperature of the oil. Therefore, an oil level adjusting operation time by the oil amount adjusting mechanism of the vehicle automatic transmission can be extended, thus improving the work efficiency.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 conceptually illustrates configurations of a drive system and a control system . in accordance with a vehicle drive device to which the present invention is applied;

FIG. 2 is a cross-sectional view for illustrating a configuration of an oil amount adjusting mechanism provided in an oil pan in the vehicle drive device in FIG. 1;

FIG. 3 is a function block diagram that illustrates essential parts of a control function included in an electronic control device in the vehicle drive device in FIG. 1;

FIG. 4 is a map that illustrates the relationship between an oil temperature and a target engine revolution number and is used when the engine revolution number is controlled according to the oil temperature to maintain an oil surface height regardless of the oil temperature in an oil surface height maintenance control section in the electronic control device in FIG. 3;

FIG. 5 is a flowchart that illustrates an example of a control operation that allows an operator to execute an oil level adjusting operation by using the oil amount adjusting mechanism in FIG. 2 in the electronic control device in FIG. 3; and

FIG. 6 is a time chart in a case where the control operation illustrated in FIG. 5 is executed.

### DETAILED DESCRIPTION OF EMBODIMENTS

An embodiment of the present invention will hereinafter be described in detail with reference to drawings.

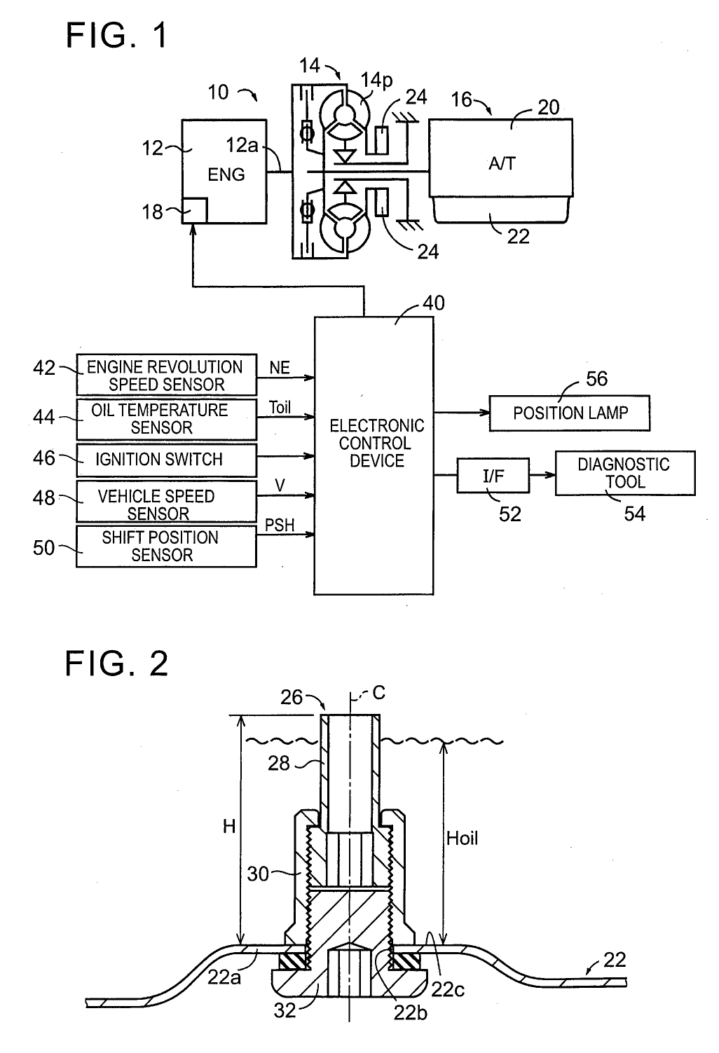

FIG. 1 schematically illustrates configurations of a drive system and a control system of a vehicle drive device 10 in accordance with one embodiment of the present invention. As shown in FIG. 1, the vehicle drive device 10 includes an engine 12 that functions as a drive source, driving force generated by the engine 12 is transmitted to an unillustrated pair of driving wheels via a torque converter 14 and an automatic transmission (vehicle automatic transmission) 16.

The engine 12 is an internal combustion engine such as a gasoline engine of an in-cylinder injection type in which fuel is directly injected in a combustion chamber, for example. An output control device 18 is provided that includes a throttle actuator that controls opening and closing of an electronic throttle valve, a fuel injection device that controls fuel injection, an ignition device that controls ignition timing, and the like for controlling the drive (output torque) of the engine 12. The output control device 18 controls opening and closing of the electronic throttle valve by the throttle actuator for throttle control according to a command supplied from an electronic control device (control device) 40 that will be described below. Further, the electronic control device 40 controls the fuel injection by the fuel injection device for fuel injection control and the ignition timing by the ignition device for ignition timing control and thereby executes output control of the engine 12.

A plurality of members that require oil such as gears for shifting and a hydraulic clutch are contained in a case 20 of the automatic transmission 16, and oil supplied thereto is stored in an oil pan (oil storage container) 22 that is connected to a lower portion of the case 20. An oil pump 24 is coupled to a pump wheel 14p of the torque converter 14. When the oil pump 24 is driven by rotation of a crankshaft 12a of the engine 12, the oil stored in the oil pan 22 is pumped up. The pumped-up oil is supplied to each of the members in the automatic transmission 16 that requires the oil.

The oil stored in an oil pan 22 is in advance adjusted to an appropriate oil amount and sealed therein. For example, if the oil amount is excessive, the areas of rotational members such as the gears that are immersed in the oil becomes large, the rotational resistance (stirring resistance) of the rotational members thus becomes high, and fuel efficiency is lowered. On the other hand, when the oil amount is insufficient, sufficient oil cannot be supplied to the gears and the hydraulic clutch, resulting in seizure of the gears and influencing the shifting. Therefore, an appropriate oil amount that restricts lowering of the fuel efficiency in a range where the seizure and the influence on the shifting are prevented is experimentally obtained in advance, and the obtained oil amount is sealed in the oil pan 22.

When the oil amount that is stored in the oil pan 22 is adjusted, an oil amount adjusting mechanism 26 provided in the oil pan 22 is used. FIG. 2 is a cross-sectional view of the oil amount adjusting mechanism 26.

As shown in FIG. 2, the oil amount adjusting mechanism 26 includes a columnar drain hole 22b that is formed, in a bottom wall 22a of the oil pan 22, a tubular discharge tube 28 that is vertically disposed in the drain hole 22b in a liquid-tight manner, a tubular seat plug 30 that is fixed to an outer periphery of the drain hole 22b on an inner wall surface 22c of the bottom wall 22a of the oil pan 22 by welding or the like in a liquid-tight manner so as to fix the discharge tube 28 to the bottom wall 22a of the oil pan 22, and a drain plug 32 that blocks the drain hole 22b. In the discharge tube 28 fixed to the seat plug 30, a discharge height H of the discharge tube 28, that is, a height H from an upper end of the discharge tube 28 to the bottom wall 22a of the oil pan 22 in an axis C direction of the discharge tube 28 is set the same as an oil surface height (oil level) Hₒᵢₗ for the optimal oil amount at a predetermined oil temperature, for example, 40° C. in this embodiment.

The vehicle drive device 10 includes a control system exemplified in FIG. 1. The electronic control device 40 shown in FIG. 1 is configured to include a “microcomputer” that includes a CPU, a RAM, a ROM, an input-output interface, and the like. The CPU utilizes a temporary storage function of the RAM to perform signal processing according to a program that is in advance stored in the ROM and thereby executes various kinds of control such as drive control of the engine 12.

As shown in FIG. 1, the electronic control device 40 is supplied with various kinds of input signals detected by each sensor provided in the vehicle drive device 10. For example, a signal that indicates an engine revolution number NE (rpm) detected by an engine revolution speed sensor 42, a signal that indicates an oil temperature Tₒᵢₗ (° C.) in the oil pan 22 that is detected by an oil temperature sensor 44, a signal that indicates an operational position or the like of an ignition switch 46, a signal that indicates a vehicle speed V (km/h) detected by a vehicle speed sensor 48, a signal that indicates a shift position PSH of the shift lever that is detected by a shift position sensor 50, and the like are input to the electronic control device 40.

The electronic control device 40 supplies various kinds of output signals to each device provided in the vehicle drive device 10. For example, a signal that is supplied to an output control device 18 of the engine 12 for drive control of the engine 12, a signal that is supplied to a diagnostic tool 54 as an information display device with a liquid crystal panel, for example, that is connected to the electronic control device 40 via an I/F (interface) 52, a signal that is supplied to a position lamp 56 for a D range that is provided in an instrumental panel, and the like are supplied from the electronic control device 40 to each section.

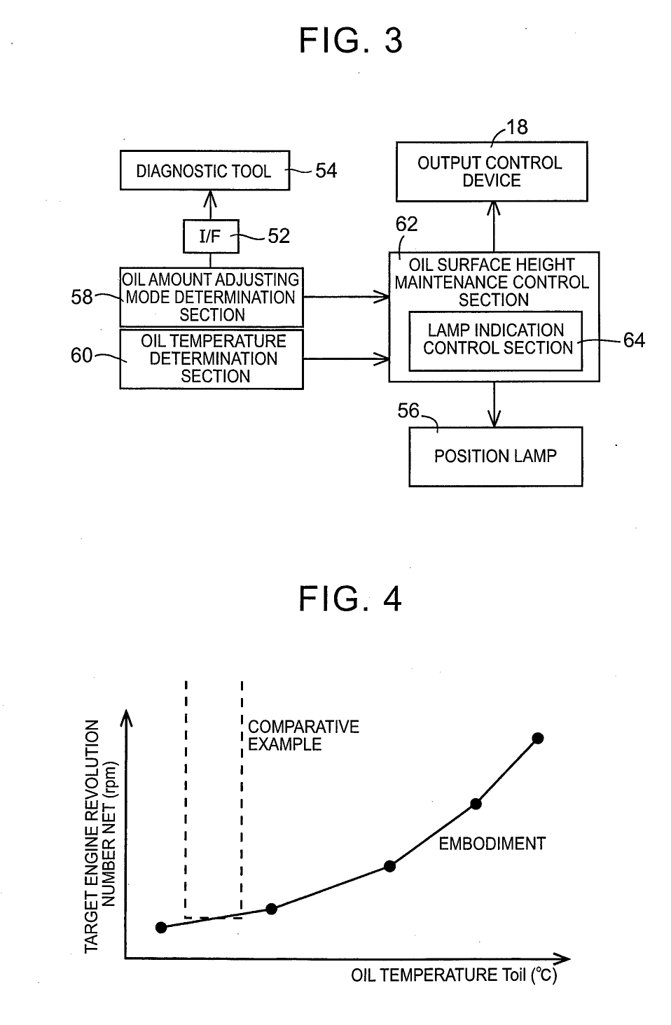

FIG. 3 is a function block diagram that illustrates essential parts of a control function included in the electronic control device 40. An oil amount adjusting mode determination section 58 shown in FIG. 3 makes a determination whether or not an oil amount adjusting mode for adjusting the oil amount stored in the oil pan 22 by the oil amount adjusting mechanism 26 is in progress. The oil amount adjusting mode determination section 58 determines that the oil amount adjusting mode is in progress if the following two operations are sequentially made when the vehicle is standing still, the ignition switch 46 is turned ON, and the engine 12 is operating. In a first operation, the diagnostic tool 54 is connected to the electronic control device 40 via the I/F 52, and, an operation in which the shift lever is moved from an N position to the D position and returned from the D position to the N position is performed within 1.5 seconds, and this N to D and D to N operations are carried out for 6 seconds continuously. In a second operation, the shift lever is moved to a non-travel position such as the N position or a P position. Meanwhile, the oil amount adjusting mode determination section 58 determines that the oil amount adjusting mode is canceled and the oil amount adjusting mode is not in progress if the above condition is not satisfied in the oil amount adjusting mode, for example, in a case where the ignition switch 46 is turned OFF or the vehicle starts traveling. After the oil amount adjusting mode determination section 58 determines whether or not the oil amount adjusting mode is in progress, the determination is displayed on the diagnostic tool 54.

An oil temperature determination section 60 consistently detects the oil temperature Tₒᵢₗ (° C.) by the signal from the oil temperature sensor 44. The oil temperature determination section 60 determines whether or not the detected oil temperature Tₒᵢₗ exceeds a prescribed temperature T1 (° C.) that is predetermined (Tₒᵢₗ>T1), for example, 40° C. in this embodiment. The oil temperature of 40° C. is set so that the discharge height H of the discharge tube 28 in the oil amount adjusting mechanism 26 becomes the same as the oil surface height Hₒᵢₗ for the optimum oil amount.

When the oil temperature Tₒᵢₗ becomes the temperature T1 that is appropriate for the oil level adjusting operation by the oil amount adjusting mechanism 26, an oil surface height maintenance control section 62 controls the engine revolution number NE according to the oil temperature Tₒᵢₗ so as to extend a period in which the oil surface height Hₒᵢₗ at the oil temperature T1 is maintained in an appropriate range. In other words, the oil surface height maintenance control section 62 performs next control if the oil amount adjusting mode determination section 58 determines that the oil amount adjusting mode is in progress and the oil temperature determination section 60 determines that the oil temperature exceeds the appropriate temperature for the oil level adjusting operation by the oil amount adjusting mechanism 26, that is, the prescribed temperature T1 (40° C.). The oil surface height maintenance control section 62 uses a map shown in FIG. 4 to set a target engine revolution number NE_{T} (rpm) from the oil temperature Tₒᵢₗ detected by the oil temperature sensor 44 and controls the output control device 18 such that the engine revolution number NE becomes the target engine revolution number NE_{T}. The oil surface height maintenance control section 62 finishes the control, for example, if the engine revolution number NE becomes a prescribed engine revolution number NE1 (for example, 1500 rpm) or higher when the oil surface height maintenance control section 62 uses the map in FIG. 4 to control the engine revolution number NE according to the oil temperature Tₒᵢₗ so as to maintain the oil surface height Hₒᵢₗ in the appropriate range. The oil surface height maintenance control section 62 thereafter controls the engine 12 to drive at a normal engine revolution number, that is, an idling engine revolution number.

The map of FIG. 4 used by the oil surface height maintenance control section 62 is experimentally set in advance such that the oil surface height Hₒᵢₗ is maintained regardless of the oil temperature Tₒᵢₗ in consideration of the oil surface height Hₒᵢₗ that rises in response to the oil temperature Tₒᵢₗ that increases at a constant engine revolution number NE of the engine 12 and the oil surface height Hₒᵢₗ that lowers in response to the engine revolution number NE that increases at a constant oil temperature Tₒᵢₗ. When the oil temperature Tₒᵢₗ is increased at the constant engine revolution number NE of the engine 12, the oil surface height Hₒᵢₗ rises in response to an increase in a returning oil amount from each section in the automatic transmission 16 due to an increase in the oil volume and a decrease in the oil viscosity. Meanwhile, when the engine revolution number NE is increased at the constant oil temperature Tₒᵢₗ, the oil surface height Hₒᵢₗ lowers because a pumped-up oil amount by the oil pump 24 exceeds the returning oil amount from each section of the automatic transmission 16.

A lamp indication control section 64 controls turning-on or flashing of the position lamp 56 of the D range to notify an operator whether or not the oil level adjusting operation can be executed by the oil amount adjusting mechanism 26. In other words, the lamp indication control section 64 turns on the position lamp 56 of the D range if the oil amount, adjusting mode determination section 58 determines that the oil amount adjusting mode is in progress and the oil temperature determination section 60 determines that the appropriate temperature T1 for the oil level adjusting operation by the oil amount adjusting mechanism 26 is obtained. The lamp indication control section 64 keeps the position lamp 56 of the D range turned on while the oil surface height maintenance control section 62 controls the engine revolution number NE according to the oil temperature Tₒᵢₗ so as to maintain the oil surface height Hₒᵢₗ in the appropriate range. When the engine revolution number NE exceeds the prescribed engine revolution number NE1 in the oil surface height maintenance control section 62, the position lamp 56 of the D range is turned on. That is, the lamp indication control section 64 notifies the operator by turning on the position lamp 56 of the D range that the oil level adjusting operation by the oil amount adjusting mechanism 26 can be executed and notifies the operator by flashing the position lamp 56 of the D range that the oil level adjusting operation cannot be executed. The lamp indication control section 64 turns off the position lamp 56 of the D range if the oil amount adjusting mode determination section 58 determines that the oil amount adjusting mode is not in progress.

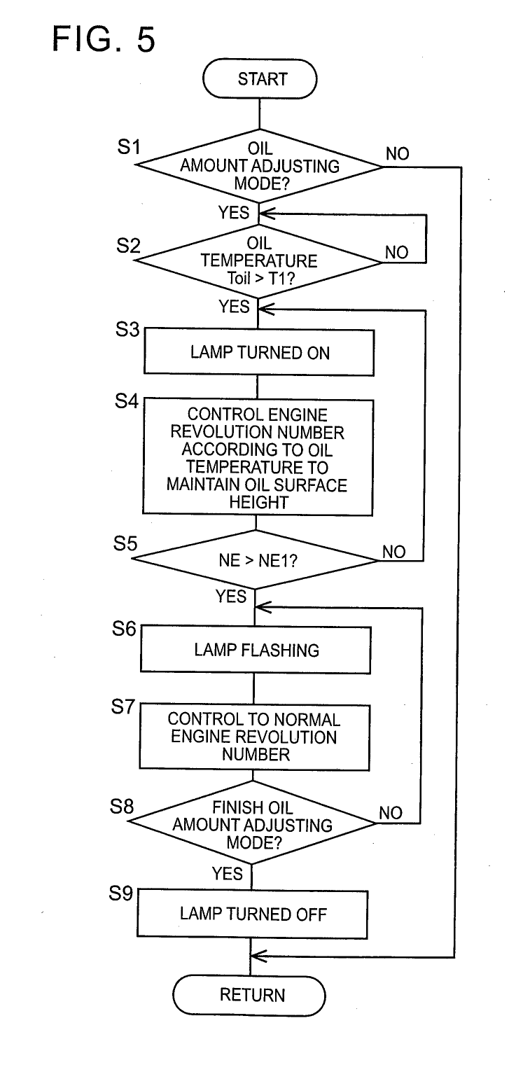

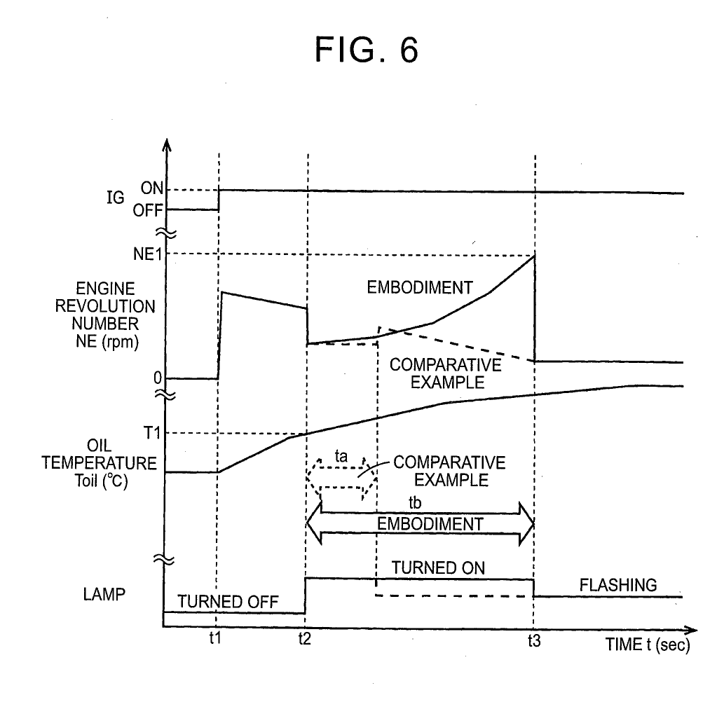

FIG. 5 is a flowchart that illustrates an example of a control operation that allows the operator to execute the oil level adjusting operation by using the oil amount adjusting mechanism 26 in the electronic control device 40. FIG. 6 is a time chart in a case where the control operation illustrated in FIG. 5 is executed.

A determination is first made in step (“step” will be omitted hereinafter) S1 that corresponds to the oil amount adjusting mode determination section 58 whether or not the oil amount adjusting mode is performed. If the determination in S1 is negative, this routine is finished. However, if the determination is affirmative (at a point t1 in FIG. 6), S2 that corresponds to the oil temperature determination section 60 is executed. A determination is made in above S2 whether or not the oil temperature Tₒᵢₗ exceeds the temperature T1 that is appropriate for the oil level adjusting operation by the oil amount adjusting mechanism 26. If the determination in S2 is negative, above S2 is repeatedly executed. However, if the determination is affirmative (at a point t2 in FIG. 6), S3 that corresponds to the lamp indication control section 64 is executed. In above S3, the position lamp S6 of the D range is turned on.

Next, in S4 that corresponds to the oil surface height maintenance control section 62, the engine revolution number NE is controlled by using the map of FIG. 4 and according to the oil temperature Tₒᵢₗ so as to maintain the oil surface height Hₒᵢₗ at the temperature T1 that is appropriate for the oil level adjusting operation in the appropriate range. A determination is next made in S5 that corresponds to the oil surface height maintenance control section 62 whether or not the engine revolution number NE exceeds the prescribed engine revolution number NE1. If the determination in S5 is negative, above S3 and S4 are repeatedly executed. However, if the determination is affirmative (at a point t3 in FIG. 6), S6 that corresponds to the oil surface height maintenance control section 62 and the lamp indication control section 64 is executed. In above S6, the control executed in S4 is finished, and the position lamp 56 of the D range flashes.

Next, in S7 that corresponds to the oil surface height maintenance control section 62, the engine 12 is controlled to drive at the normal engine revolution number, that is, the idling engine revolution number. A determination is next made in S8 that corresponds to the oil amount adjusting mode determination section 58 whether or not the oil amount adjusting mode is finished, that is, the oil amount adjusting mode is not in progress. If the determination in S8 is negative, above S6 and S7 are repeatedly executed. However, if the determination is affirmative, S9 that corresponds to the lamp indication control section 64 is executed, and the position lamp 56 of the D range is turned off.

While the position lamp 56 of the D range is turned on between t2 and t3 in FIG. 6, the operator uses the oil amount adjusting mechanism 26 to perform the oil level adjusting operation. In other words, in this embodiment, the time between t2 and t3 in FIG. 6 serves as an oil level adjusting operation time tb by the oil amount adjusting mechanism 26. In the oil level adjusting operation by the oil amount adjusting mechanism 26, the operator first detaches the drain plug 32 of the oil amount adjusting mechanism 26 and introduces the oil through an unillustrated oil introduction hole that is formed in the case 20 of the automatic transmission 16. The oil surface height Hₒᵢₗ of the oil pan 22 gradually rises when the oil is introduced. When the oil surface height Hₒᵢₗ exceeds the discharge height H of the discharge tube 28, the oil passes through the discharge tube 28 and is discharged from the drain hole 22b. The operator confirms that the oil is discharged from the drain hole 22b, stops introducing the oil, and blocks the drain plug 32. Accordingly, the oil amount stored in the oil pan 22 is adjusted to the optimal oil amount.

FIG. 4 and FIG. 6 show broken lines that represent a comparative example where control for keeping a constant engine revolution number is performed after the oil temperature T1 that is appropriate for the oil level adjusting operation is obtained. Solid lines in FIG. 4 and FIG. 6 represent this embodiment. As shown in FIG. 6, in this embodiment represented by the solid lines, after the oil temperature T1 that is appropriate for the oil level adjusting operation is obtained, the engine revolution number NE is controlled according to the oil temperature Tₒᵢₗ so as to extend the period in which the oil surface height Hₒᵢₗ at the temperature T1 is maintained in the appropriate range. Therefore, the oil level adjusting operation time tb (sec) by the oil amount adjusting mechanism 26 in this embodiment becomes longer than an oil level adjusting operation time ta (sec) by the oil amount adjusting mechanism 26 in the comparative example.

As described above, according to the electronic control device 40 of this embodiment, the oil surface height maintenance control section 62 controls the engine revolution number NE so as to maintain the oil surface height Hₒᵢₗ in the predetermined appropriate range regardless of the oil temperature Tₒᵢₗ. Accordingly, the oil level adjusting operation time tb by the oil amount adjusting mechanism 26 of the automatic transmission 16 can be made longer, thus improving the work efficiency.

One embodiment of the present invention has been described in detail so far with reference to the drawings. However, the present invention is applied to other embodiments.

For example, when the map of FIG. 4 is used to control the engine revolution number NE according to the oil temperature Tₒᵢₗ, the oil surface height maintenance control section 62 in the above-described embodiment finishes the control when the engine revolution number NE becomes the prescribed engine revolution number NE1 or higher. However, the control may be finished when the oil temperature Tₒᵢₗ becomes a prescribed oil temperature or higher, for example.

It should be noted that the above-described embodiment is merely one embodiment but the present invention can be practiced in modes with various modifications or improvements on the basis of knowledge of persons having ordinary skill in the art.

1. A control device for a vehicle, the control device comprising:
an oil pump configured to be driven by an engine;
an oil storage container of an automatic transmission of the vehicle, the oil storage container including a discharge rube and a bottom wall that includes a drain hole, the tube connecting to the drain hole, the discharge tube configured to discharge oil in the oil storage container through the drain hole and the discharge tube, the discharge tube being configured to discharge oil that exceeds a discharge height that is defined by a height of the discharge tube;
an electronic control device configured to control a revolution number of the engine so as to maintain, even when a temperature of the oil increases, an oil surface height of the oil in a predetermined appropriate range during adjustment of an oil level in the oil storage container by using the discharge tube, the predetermined appropriate range being the oil surface height that is appropriate for the adjustment of the oil level.

2. The control device according to claim 1, wherein the electronic control device is configured to increase the revolution number of the engine as the temperature of the oil increases.

3. The control device according to claim 2, wherein the electronic control device is configured to finish control in which the revolution number of the engine is increased as the temperature of the oil increases when the revolution number of the engine becomes a predetermined value or higher.

4. The control device according to claim 2, wherein the electronic control device is configured to finish control in which the revolution number of the engine is increased as the temperature of the oil increases when the temperature of the oil becomes a predetermined value or higher.
